(19) United States
(12) Patent Application Publication
(10) Pub. No.: US 2024/0001166 A1
(43) Pub. Date: Jan. 4, 2024

(54) METHOD AND SYSTEM OF AIR PARAMETER BASED AUTOMATIC BYPASSING OF A SOURCE OF BREATHABLE AIR IN A FIREFIGHTER AIR REPLENISHMENT SYSTEM IMPLEMENTED WITHIN A STRUCTURE

(71) Applicant: Anthony J. Turiello, Westlake, TX (US)

(72) Inventor: Anthony J. Turiello, Westlake, TX (US)

(21) Appl. No.: 18/131,369

(22) Filed: Apr. 6, 2023

Related U.S. Application Data
(60) Provisional application No. 63/427,850, filed on Nov. 24, 2022.
(60) Provisional application No. 63/356,996, filed on Jun. 29, 2022.

(51) Int. Cl. A62B 13/00; A62B 7/02; A62B 15/00

(52) U.S. Cl. CPC A62B 13/00; A62B 15/00; A62B 7/02

(57) ABSTRACT

Disclosed are methods and a safety system of a structure for an air parameter based automatic bypassing of a source of breathable air within the safety system. In accordance therewith, an air analysis device is installed within the safety system along an air flow path of the breathable air from the source thereof. The safety system has a fixed piping system installed within the structure for supply of the breathable air across the safety system. A sensor associated with the air analysis device automatically detects a parameter of the breathable air circulating within the safety system. In response to detecting that the parameter of the breathable air is outside a predetermined threshold value, through a bypass controller device communicatively coupled to the air analysis device, the source of the breathable air is automatically bypassed with respect to the supply of the breathable air across the safety system.

### CLAIM OF PRIORITY

This Application is a conversion application of, and claims priority to, U.S. Provisional Patent Application No. 63/427,850 titled AUTOMATED BYPASS OF STORED BREATHABLE AIR BASED UPON CONFIRMATION OF AN ALERT STATUS BY A REMOTE CERTIFICATION LABORATORY ANALYZING AIR QUALITY MARKER DATA CAPTURED USING SENSORS ASSOCIATED WITH A CONTINUAL AIR QUALITY ANALYZER COUPLED WITHIN A FIREFIGHTER AIR REPLENISHMENT SYSTEM filed on Nov. 24, 2022 and U.S. Provisional Patent Application No. 63/356,996 titled CLOUD-BASED FIREFIGHTING AIR REPLENISHMENT MONITORING SYSTEM, SENSORS AND METHODS filed on Jun. 29, 2022. The contents of each of the aforementioned applications are incorporated herein by reference in entirety thereof.

### FIELD OF TECHNOLOGY

This disclosure relates generally to emergency systems and, more particularly, to methods and/or a system of air parameter based automatic bypassing of a source of breathable air in a safety system implemented within a structure.

### BACKGROUND

A structure (e.g., a vertical building, a horizontal building, a tunnel, marine craft, a mine) may have a Firefighter Air Replenishment System (FARS) implemented therein. The FARS may be employed to provide pure and safe breathable air to emergency personnel and/or maintenance personnel associated therewith. During contamination of the breathable air through the FARS and/or anomalous levels of components (e.g., carbon monoxide, carbon dioxide) thereof, the emergency and/or the maintenance personnel may be exposed to adverse health and/or life hazards thereto. Further, leaks of the breathable air within the FARS may cause catastrophic losses thereof that are also life threatening to the emergency and/or the maintenance personnel.

### SUMMARY

Disclosed are methods and/or a system of air parameter based automatic bypassing of a source of breathable air in a safety system implemented within a structure.

In one aspect, a method of a safety system of a structure having a fixed piping system installed therewithin to supply breathable air from a source across the safety system is disclosed. The method includes sensing a parameter of the breathable air circulating within the safety system, and, in response to detecting that the parameter of the breathable air is outside a predetermined threshold value based on the sensing, automatically bypassing the source of the breathable air with respect to the supply of the breathable air across the safety system.

In another aspect, a method of a safety system of a structure having a fixed piping system installed therewithin to supply breathable air from a source across the safety system is disclosed. The method includes sensing a parameter of the breathable air circulating within the safety system. The method also includes, in response to detecting that the parameter of the breathable air is outside a predetermined threshold value based on the sensing, automatically bypassing the source of the breathable air with respect to the supply of the breathable air across the safety system, and switching from the source of the breathable air to another source of the breathable air in the safety system in addition to the automatic bypassing of the source of the breathable air to ensure a continued supply of the breathable air across the safety system.

In yet another aspect, the safety system of the structure includes a source of breathable air, and a fixed piping system installed within the structure for supply of the breathable air across the safety system. The safety system also includes an air analysis device along an air flow path of the breathable air from the source thereof. The air analysis device includes a sensor associated therewith to automatically detect a parameter of the breathable air circulating within the safety system. Further, the safety system includes a bypass controller device communicatively coupled to the air analysis device to, in response to detecting that the parameter of the breathable air is outside a predetermined threshold value, automatically bypass the source of the breathable air with respect to the supply of the breathable air across the safety system.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1A is a schematic and an illustrative view of a safety system associated with a structure, according to one or more embodiments.

FIG. 1B is a schematic view of the safety system of FIG. 1A integrated with and/or including other components, according to one or more embodiments.

FIG. 2 is a schematic view of an air quality analysis device of the safety system of FIGS. 1A-B, according to one or more embodiments.

FIG. 3 is a schematic view of example constituent sensors within the air quality analysis device of FIGS. 1A-B and FIG. 2.

FIG. 4 is a schematic and an illustrative view of an example air monitoring system of the safety system of FIGS. 1A-B.

FIG. 5 is a schematic and an illustrative view of an example display unit associated with the air quality analysis device of the air monitoring system of FIG. 4.

FIG. 6 is a schematic and an illustrative view of an example air quality analysis device of the safety system of FIGS. 1A-B.

FIG. 7 is a schematic and an illustrative view of the safety system of FIGS. 1A-B implemented in a horizontal configuration of the structure thereof and communication therewithin, according to one or more embodiments.

FIG. 8 is an example user interface view of an air safety application executing on a data processing device of FIG. 1B and FIG. 7.

FIG. 9 is a schematic view of control of valves remotely from an External Mobile Air Connection (EMAC) panel of the safety system of FIG. 1B and FIG. 7, according to one or more embodiments.

FIG. 10 is a process flow diagram detailing the operations involved in air parameter based automatic bypassing of a source of breathable air in a safety system implemented within a structure, according to one or more embodiments.

Other features of the present embodiments will be apparent from the accompanying drawings and from the detailed description that follows.

### DETAILED DESCRIPTION

Example embodiments, as described below, may be used to provide methods and/or a system of air parameter based automatic bypassing of a source of breathable air in a safety system implemented within a structure. Although the present embodiments have been described with reference to specific example embodiments, it will be evident that various modifications and changes may be made to these embodiments without departing from the broader spirit and scope of the various embodiments.

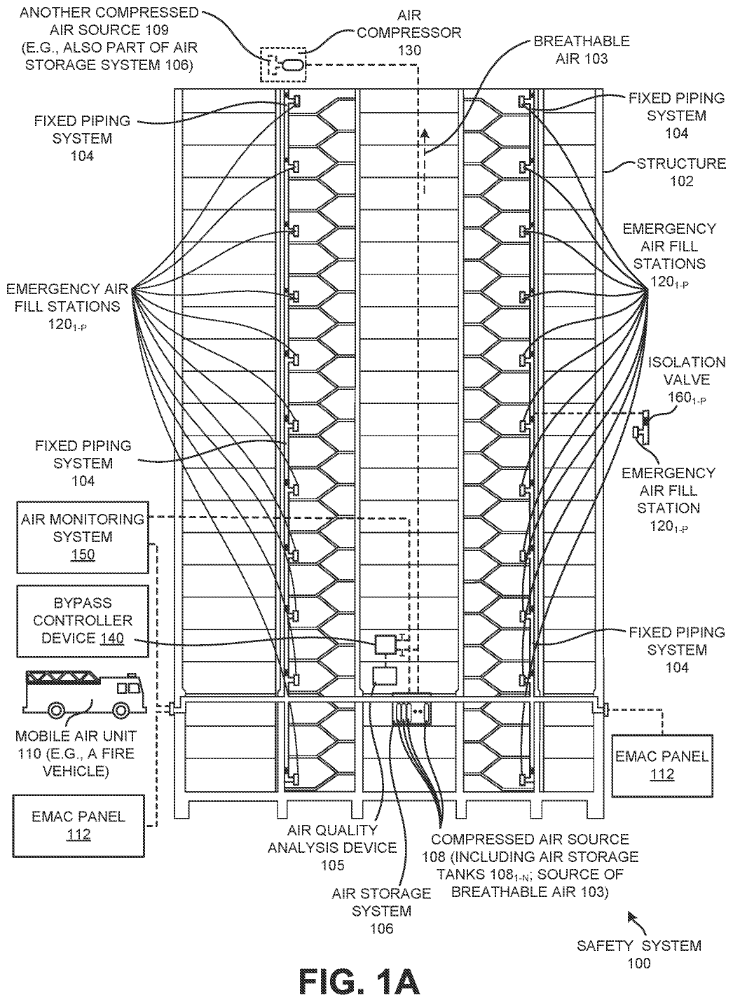

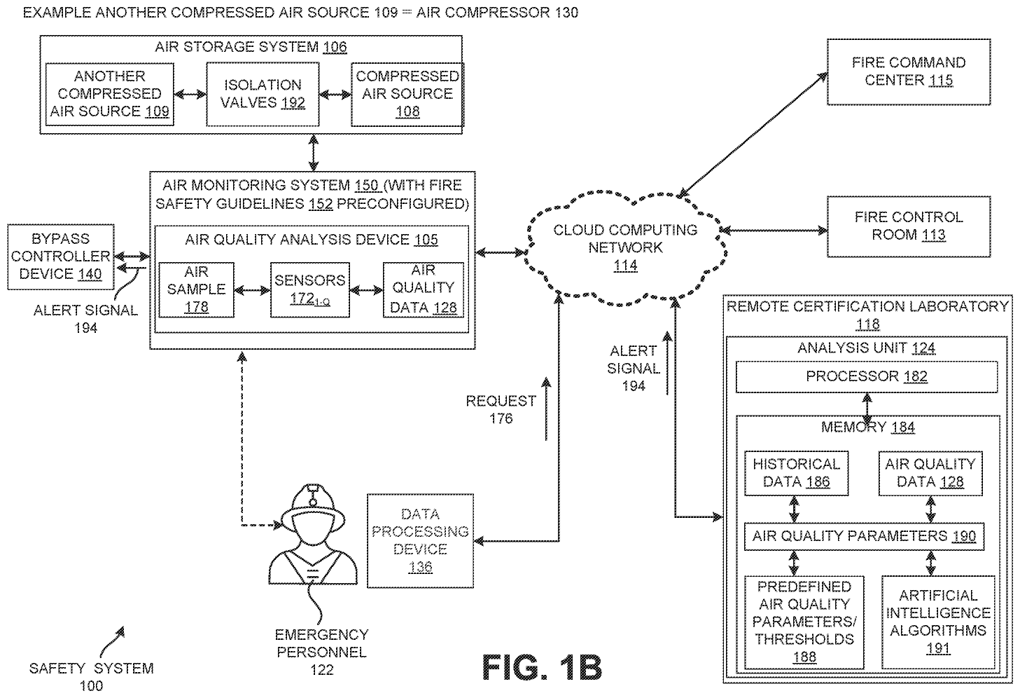

FIG. 1A shows a safety system 100 associated with a structure 102, according to one or more embodiments. In one or more embodiments, safety system 100 may be a Firefighter Air Replenishment System (FARS) to enable firefighters entering structure 102 in times of fire-related emergencies to gain access to breathable (e.g., human breathable) air (e.g., breathable air 103) in-house without the need of bringing in air bottles/cylinders to be transported up several flights of stairs of structure 102 or deep thereinto, or to refill depleted air bottles/cylinders that are brought into structure 102. In one or more embodiments, safety system 100 may supply breathable air provided from a supply of air tanks (to be discussed) stored in structure 102. When a fire department vehicle arrives at structure 102 during an emergency, breathable air supply typically may be provided through a source of air connected to said vehicle. In one or more embodiments, safety system 100 may enable firefighters to refill air bottles/cylinders thereof at emergency air fill stations (to be discussed) located throughout structure 102. Specifically, in some embodiments, firefighters may be able to fill air bottles/cylinders thereof at emergency air fill stations within structure 102 under full respiration in less than one to two minutes.

In one or more embodiments, structure 102 may encompass vertical building structures, horizontal building structures (e.g., shopping malls, hypermarts, extended shopping, storage and/or warehousing related structures), tunnels, marine craft (e.g., large marine vessels such as cruise ships, cargo ships, submarines and large naval craft, which may be “floating” versions of buildings and horizontal structures) and mines. Other structures are within the scope of the exemplary embodiments discussed herein. In one or more embodiments, safety system 100 may include a fixed piping system 104 permanently installed within structure 102 serving as a constant source of replenishment of breathable air 103. Fixed piping system 104 may be regarded as being analogous to a water piping system within structure 102 or another structure analogous thereto for the sake of imaginative convenience.

As shown in FIG. 1A, fixed piping system 104 may distribute breathable air 103 across floors/levels of structure 102. For the aforementioned purpose, fixed piping system 104 may distribute breathable air 103 from an air storage system 106 (e.g., within structure 102) including a number of air storage tanks 108_{1-N} that serve as sources of pressurized/compressed air (e.g., breathable air 103). Additionally, in one or more embodiments, fixed piping system 104 may interconnect with a mobile air unit 110 (e.g., a fire vehicle) through an External Mobile Air Connection (EMAC) panel 112.

In one or more embodiments, EMAC panel 112 may be a boxed structure (e.g., exterior to structure 102) to enable the interconnection between mobile air unit 110 and safety system 100. For example, mobile air unit 110 may include an on-board air compressor to store and replenish pressurized/compressed air (e.g., breathable air analogous to breathable air 103) in air bottles/cylinders (e.g., utilizable with Self-Contained Breathing Apparatuses (SCBAs) carried by firefighters). Mobile air unit 110 may also include other pieces of air supply/distribution equipment (e.g., piping and/or air cylinders/bottles) that may be able to leverage the sources of breathable air 103 within safety system 100 through EMAC panel 112. Firefighters, for example, may be able to fill breathable air (e.g., breathable air 103, breathable air analogous to breathable air 103) into air bottles/cylinders (e.g., spare bottles, bottles requiring replenishment of breathable air) carried on mobile air unit 110 through safety system 100.

In FIG. 1A, EMAC panel 112 is shown at two locations merely for the sake of illustrative convenience. In one or more embodiments, an air monitoring system 150 may be installed as part of safety system 100 to automatically track and monitor a parameter (e.g., pressure) and/or a quality (e.g., indicated by moisture levels, carbon monoxide levels) of breathable air 103 within safety system 100. FIG. 1A shows air monitoring system 150 as communicatively coupled to air storage system 106 and EMAC panel 112 merely for the sake of example. It should be noted that EMAC panel 112 may be at a remote location associated with (e.g., internal to, external to) structure 102. In one or more embodiments, for monitoring the parameters and/or the quality of breathable air within safety system 100, air monitoring system 150 include appropriate sensors and circuitries therein. For example, a pressure sensor (to be discussed) within air monitoring system 150 may automatically sense and record a pressure of breathable air 103 of safety system 100. Said pressure sensor may communicate with an alarm system that is triggered when the sensed pressure is outside a safety range. Also, in one or more embodiments, air monitoring system 150 may automatically trigger a shutdown of breathable air distribution through safety system 100 in case of impurity/contaminant (e.g., carbon monoxide) detection therethrough yielding levels above a safety/predetermined threshold.

In one or more embodiments, fixed piping system 104 may include pipes (e.g., constituted out of stainless steel tubing) that distribute breathable air 103 to a number of emergency air fill stations 120_{1-P} within structure 102. In one example implementation, each emergency air fill station 120_{1-P} may be located at a specific level of structure 102. If structure 102 is regarded as a vertical building structure, an emergency air fill station 120_{1-P} may be located at each of a basement level, a first floor level, a second floor level and so on. For example, emergency air fill station 120_{1-P} may be located at the end of the flight of stairs that emergency fighting personnel (e.g., firefighting personnel) need to climb to reach a specific floor level within the vertical building structure.

In one or more embodiments, an emergency air fill station 120_{1-P} may be a static location within a level of structure 102 that provides emergency personnel 122 (e.g., firefighters, emergency responders) with the ability to rapidly fill air bottles/cylinders (e.g., SCBA cylinders). In one or more embodiments, emergency air fill station 120_{1-P} may be an emergency air fill panel or a rupture containment air fill station. In one or more embodiments, proximate each emergency air fill station 120_{1-P}, safety system 100 may include an isolation valve 160_{1-P} to isolate a corresponding emergency air fill station 120_{1-P} from a rest of safety system 100. For example, said isolation may be achieved through the manual turning of isolation valve 160_{1-P} proximate the corresponding emergency air fill station 120_{1-P} or remotely (e.g., based on automatic turning) from air monitoring system 150. In one example implementation, air monitoring system 150 may maintain breathable air supply to a subset of emergency air fill stations 120_{1-P} through control of a corresponding subset of isolation valves 160_{1-P} and may isolate the other emergency air fill stations 120_{1-P} from the breathable air supply. It should be noted that configurations and components of safety system 100 may vary from the example safety system 100 of FIG. 1A.

FIG. 1B shows safety system 100 of FIG. 1A integrated with and/or including other components, according to one or more embodiments. In one or more embodiments, safety system 100 shows air storage system 106 discussed above as including air storage tanks 108_{1-N} (example pressurized/compressed air source shown as compressed air source 108) and air compressor 130. In some embodiments, air compressor 130 may be regarded as another compressed air source 109 internal to or external to structure 102, as will be discussed below. In one or more embodiments, air monitoring system 150 discussed above may include an air quality analysis device 105 (e.g., a programmable electromechanical device) to determine quality of breathable air 103 within safety system 100. In order to do this, in one or more embodiments, air quality analysis device 105 may be communicatively coupled to air storage system 106.

In one or more embodiments, air quality analysis device 105 may continuously and/or intermittently measure and analyze components of breathable air 103 within safety system 100. Further, in one or more embodiments, air quality analysis device 105 may compare the results of the analyses to standard fire safety guidelines 152 pertaining to the breathable air (e.g., breathable air 103) programmed therewithin, as shown in FIG. 1B. Alternatively or additionally, in some embodiments, standard fire safety guidelines 152 may exist on an external device (e.g., data processing device 136 to be discussed below/server) and accessed through air quality analysis device 105.

In one or more embodiments, air quality analysis device 105 may include a set of sensors 172_{1-Q} to monitor parameters associated with quality of breathable air 103 and components thereof within safety system 100. In one or more embodiments, sensors 172_{1-Q} may continuously (and automatically be programmed to) monitor the quality of breathable air 103 from air storage system 106 that is being supplied to the various emergency air fill stations 120_{1-P} within structure 102. In one or more embodiments, once a deviation in an air parameter (e.g., temperature, pressure, contamination, carbon monoxide component, carbon dioxide component etc.) is detected by sensors 172_{1-Q}, air quality analysis device 105 may automatically activate a bypass controller device 140 (e.g., another programmable/controllable electromechanical device) to automatically switch off supply of breathable air 103 from compressed air source 108.

For example, bypass controller device 140 may control isolation valves 160_{1-P} associated with emergency air fill stations 120_{1-P} to automatically bypass compressed air source 108 (e.g., air storage tanks 108_{1-N}) with respect to breathable air 103 within safety system 100; appropriate control (e.g., closing) of isolation valves 160_{1-P} may shut down breathable air 103 from compressed air source 108 to emergency air fill stations 120_{1-P}. Further, in response to the automatic bypass of compressed air source 108, bypass controller device 140 may automatically connect emergency air fill stations 120_{1-P} to another compressed air source 109 of air storage system 106 as the source of breathable air 103 within safety system 100. Here, in one or more embodiments, isolation valves 160_{1-P} may, again, be controlled to be, for example, opened to let another compressed air source 109 supply breathable air 103 within safety system 100. Thus, in one or more embodiments, the automatic switching between compressed air sources within safety system 100 may be accomplished through sensing/monitoring of parameters of breathable air 103 therewithin; such a switch may ensure a continuous, uninterrupted supply of breathable air 103 within safety system 100.

In one or more embodiments, the automatic switching between compressed air sources within safety system 100 may occur based on controlling isolation valves 192 associated with compressed air source 108 and another compressed air source 109 within air storage system 106. For example, automatic closing of an isolation valve 192 associated with compressed air source 108 within air storage system 106 and automatic opening of another isolation valve 192 associated with another compressed air source 109 based on detection of deviation in parameters of components of breathable air 103 may result in the automatic switching between compressed air sources within safety system 100. Another compressed air source 109 (e.g., air compressor 130) may be internal to structure 102 or external (e.g., mobile air unit 110 connected to safety system 100 through EMAC panel 112) thereto.

In one or more embodiments, emergency personnel 122 (e.g., firefighters, emergency responders, maintenance personnel, control room personnel) at data processing device 136 (e.g., a mobile phone, a tablet, a server, a laptop, a computing device) may request one or more air quality tests on breathable air 103 through air quality analysis device 105. In one or more embodiments, said request 176 may activate (e.g., automatically) air quality analysis device 105 to obtain an air sample 178 of breathable air 103. For example, air quality analysis device 105 may allow a predetermined quantity/volume of breathable air 103 pass through a chamber (not shown) thereof to enable air sample 178 to be procured for said one or more quality tests. Alternatively or additionally, air quality analysis device 105 may allow breathable air 103 to pass through the chamber for a predetermined duration to enable air sample 178 to be procured for the one or more quality tests.

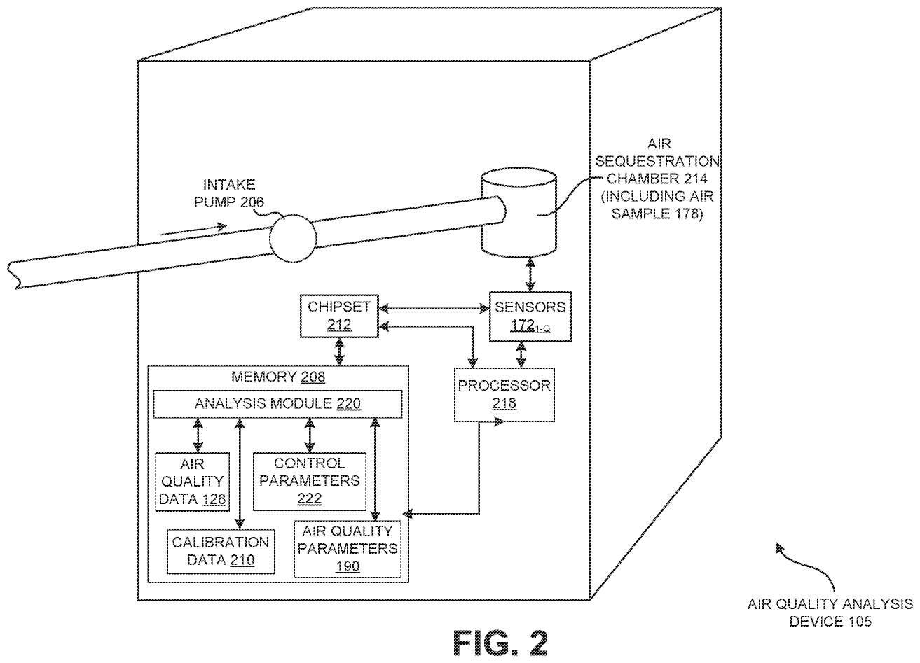

FIG. 2 shows air quality analysis device 105, according to one or more embodiments. In some embodiments, air quality analysis device 105 may be integrated with fixed piping system 104 to be along the path of flow of breathable air 103. In other embodiments, air quality analysis device 105 may be part of air monitoring device 150 or even air storage system 106. In some other embodiments, air quality analysis device 105 may merely be along a flow path of breathable air 103 of safety system 100. In one or more embodiments, air quality analysis device 105 may include an intake pump 206 to ingest a quantity/volume of breathable air 103 through fixed piping system 104 into an air sequestration chamber 214, thereby segregating air sample 178 of breathable air 103 for analysis. In one or more embodiments, air sequestration chamber 214 may be communicatively coupled to sensors 172_{1-Q} that analyze air sample 178 therewithin and perform operations and functionalities related to monitoring and/or sensing parameters related to air quality and components of breathable air 103 within safety system 100.

In one or more embodiments, a chipset 212 coupled to a memory 208 (e.g., a volatile and/or a non-volatile memory) may, in turn, be electrically coupled to sensors 172_{1-Q} to convert results of the sensing and/or monitoring into machine (e.g., a data processing device such as data processing device 136) readable/interpretatable air quality data 128 (e.g., stored in memory 208); said air quality data 128 may be communicable to a remote certification laboratory 118 (referring back to FIG. 1B) through a computing network (e.g., cloud computing network 114). Thus, in one or more embodiments, analysis and/or certification of breathable air 103 through safety system 100 by professionals may be enabled through safety system 100. As shown in FIG. 2, memory 208 and chipset 212 may be communicatively coupled to a processor 218 (e.g., a microcontroller) that executes instructions associated with the abovementioned operations and/or functionalities. For this purpose, in one or more embodiments, memory 208 may include instructions associated with an analysis module 220 stored therein that are executable through processor 218.

In one or more embodiments, remote certification laboratory 118 may analyze air quality data 128 of air sample 178 and automatically generate an alert signal 194 to activate bypass controller device 140 if anomalies (e.g., due to air contamination, particulates, pollutants, etc.) and/or faults (e.g., deviation from predefined parameters such as temperature, pressure, a proportion of air components, etc.) are detected in air quality data 128. In one or more embodiments, for the aforementioned purpose, bypass controller device 140 may automatically generate signals to control isolation valves 160_{1-P}/isolation valves 192, as discussed above. In addition, in one or more embodiments, air quality data 128 may be communicated to a fire command center 115 (e.g., a remote center with data processing capabilities), a fire control room 113 (e.g., a control room internal to or external to structure 102) and/or emergency personnel 122 at data processing device 136 through cloud computing network 114.

In one or more embodiments, remote certification laboratory 118 alone may not generate alert signal 194. In one or more embodiments, based on monitoring and/or sensing of breathable air 103 and components thereof through air quality analysis device 105 as discussed above, alert signal 194 may be directly generated through air quality analysis device 105, for example, based on an alert system shown) implemented therein. As discussed above, in accordance therewith, bypass controller device 140 coupled to air monitoring system 150 may generate signals to automatically bypass air storage system 106 (e.g., compressed air source 108) with respect to supply of breathable air 103 within safety system 100 and/or automatically switch between compressed air sources (e.g., between compressed air source 108 and another compressed air source 109 and/or vice versa).

In one or more embodiments, air quality analysis device 105 may be permanently affixed (or, along a path of breathable air 103 within fixed piping system 104) to fixed piping system 104 to avoid logistical issues related to building an analogous sensing/monitoring mechanism offsite, and/or to reduce the risk of breathing contaminated air causing harm to emergency personnel 122 during an emergency (e.g., air contamination, air pollution, fire, smoke).

In one or more embodiments, as shown in FIG. 2, memory 208 of air quality analysis device 105 may include known calibration data 210 stored therein that is used by processor 218 (e.g., by analysis module 220) to compare a characteristic/parameter of breathable air 103 therewith based on results of analysis through remote certification laboratory 118 and/or air quality analysis device 105. In one or more embodiments, in response to determining through processor 218 that the characteristic/parameter is dissimilar to one car more of known calibration data 210, control parameters 222 (e.g., stored in memory 208) of air quality analysis device 105 may be adjusted to account for said dissimilarities. Also, in one or more embodiments, air quality analysis device 105 may include appropriate circuitry to receive instructions from fire command center 115, fire control room 113 and/or data processing device 136 (emergency personnel 122) to mark/alert safety system 100 for transitioning thereof into an emergency state and/or generate trigger signals to activate bypass controller device 140 for automatic bypass of air storage system 106/compressed air source 108/another compressed air source 109 discussed above. Again, in one or more embodiments, the same functionalities may be provided to air quality analysis device 105 itself.

In one or more embodiments, as shown in FIG. 1B, remote certification laboratory 118 may include an analysis unit 124 (e.g., a data processing device such as a server) including a processor 182 (e.g., a processor core, a network of processors, a processor) communicatively coupled to a memory 184 (e.g., a volatile and/or a non-volatile memory and/or a database). In one or more embodiments, memory 184 may have historical data 186 (e.g., relevant to safety system 100 and breathable air 103 therein) and predefined air quality parameters/thresholds 188 (e.g., as per National Fire Protection Association (NFPA) standards, as per general and/or custom safety standards) for breathable air 103. In one or more embodiments, analysis unit 124 may measure air quality parameters 190 (also shown as part of memory 208 of air quality analysis device 105 to account for air quality analysis device 105 performing operations analogous to analysis unit 124 including triggering bypass controller device 140 to automatic bypass air storage system 106/compressed air source 108/another compressed air source 109 discussed above) using air quality data 128. In some embodiments, analysis unit 124 may execute one or more artificial intelligence algorithms 191 (e.g., stored in memory 184 and executable through processor 182) for advanced profiling and/or testing of breathable air 103 through safety system 100.

In some embodiments, the profiling and/or testing through analysis unit 124 of remote certification laboratory 118 may provide for accreditation of air quality of breathable air 103 within safety system 100 when the results of the profiling/testing yield that air quality parameters 190 are within the predefined air quality parameters/thresholds 188; the aforementioned accreditation may be provided in the form of a certificate to fire command center 115, fire control room 113 and/or data processing device 136 (emergency personnel 122). In some embodiments, each time safety system 100 is certified, the corresponding certification generated may be written permanently into a distributed ledger and/or a blockchain (e.g., Ethereum™ blockchain, Solana™ blockchain; part of memory 184 or a cloud version thereof) for redundant and secondary record-keeping. In addition, advanced reporting, analytics, control and/or test functions may be enabled through a mobile and/or a desktop application (e.g., executing on data processing device 136).

In one or more embodiments, when the results of the profiling/testing yield that air quality parameters 190 are not within predefined air quality parameters/thresholds 188, remote certification laboratory 118/analysis unit 124 may generate alert signal 194 to notify fire command center 115, fire control room 113 and/or data processing device 136 (emergency personnel 122) of an emergency state of safety system 100. In some implementations, alert signal 194 may automatically activate bypass controller device 140 to switch off supply of breathable air 103 from compressed air source 108/another compressed air source 109/air storage system 106 and, thereby, isolate compressed air source 108/another compressed air source 109/air storage system 106 from safety system 100. Alert signal 194 additionally may activate bypass controller device 140 to automatically connect a different compressed air source (e.g., another compressed air source 109) to safety system 100/emergency air fill stations 120_{1-P} to ensure a continuous supply of breathable air 103 within safety system 100, according to one or more embodiments.

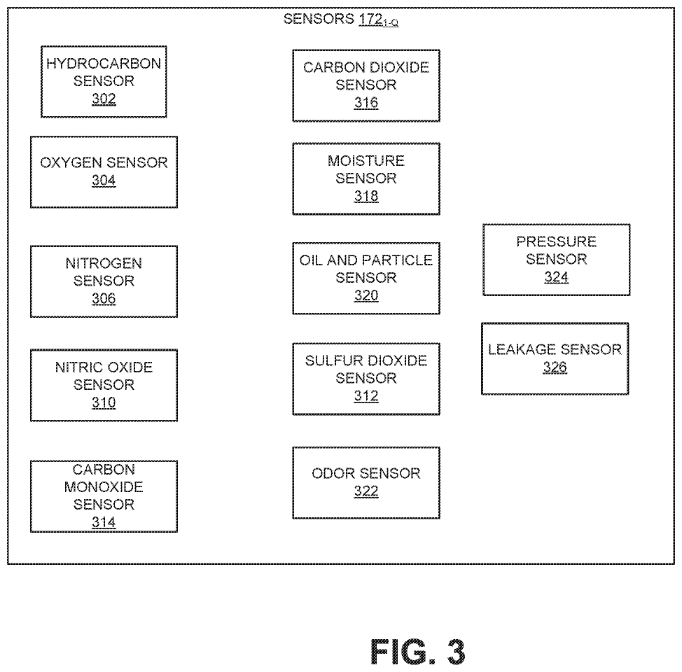

FIG. 3 shows constituent sensors of sensors 172_{1-Q}, according to one or more embodiments. In one or more embodiments, sensors 172_{1-Q} may include a hydrocarbon sensor 302 to measure a hydrocarbon level to an accuracy of, say, 0.02-0.3% absolute, an oxygen sensor 304 to measure an oxygen level to an accuracy of, say, 0.1% absolute, a nitrogen sensor 306, a nitric oxide sensor 310, a carbon monoxide sensor 314, a carbon dioxide sensor 316, a moisture sensor 318, an oil and particle sensor 320 to measure a level of oil and/or particle to an accuracy of, say, ±2% relative, a sulfur dioxide sensor 312, a pressure sensor 324, an odor sensor 322 and/or a leakage sensor 326. In one or more embodiments, the automatic bypassing of air storage system 106/compressed air source 106/another compressed air source 109 through bypass controller device 140 may be initiated when one or more of the following conditions are detected through the corresponding sensors 172_{1-Q}:
1. carbon monoxide sensor 314 detects a level of carbon monoxide in breathable air 103 in excess of a first predetermined threshold value (e.g., 4.5 parts per million; part of predefined air quality parameters/thresholds 188 shown as stored in both memory 184 and memory 208),
2. carbon dioxide sensor 316 detects a level of carbon dioxide in breathable air 103 in excess of a second predetermined threshold value (e.g., 1,000 parts per million; part of predefined air quality parameters/thresholds 188),
3. oxygen sensor 304 detects a level of oxygen in breathable air 103 outside a predetermined range of values (e.g., between 19.5% and 23.5; part of predefined air quality parameters/thresholds 188),
4. nitrogen sensor 306 detects a level of nitrogen in breathable air 103 less than a third predetermined threshold value (e.g., below 75%; part of predefined air quality parameters/thresholds 188) and/or in excess of a fourth predetermined threshold value (e.g., above 81%; part of predefined air quality parameters/thresholds 188),
5. hydrocarbon sensor 302 detects a condensed hydrocarbon content in breathable air 103 in excess of a fifth predetermined threshold value (e.g., 5 milligrams per cubic meter of breathable air 103; part of predefined air quality parameters/thresholds 188),
6. moisture sensor 318 detects a moisture concentration in breathable air 103 in excess of a sixth predetermined threshold value (e.g., 24 parts per million by volume; part of predefined air quality parameters/thresholds 188), and
7. pressure sensor 324 detects a pressure of breathable air 103 less than a seventh predetermined threshold value (e.g., below 90% of a maintenance pressure specified in a fire code; part of predefined air quality parameters/thresholds 188).

Other types of sensors that are part of sensors 172_{1-Q} have analogous predetermined threshold values/ranges (e.g., part of predefined air quality parameters/thresholds 188) associated with air quality parameters 190 sensed therethrough; such sensors 172_{1-Q} are shown in FIG. 3 and are self-explanatory. It should be noted that parameters sensed through sensors 172_{1-Q} may not be limited to air quality parameters 190; even characteristics such as pressure (e.g., through pressure sensor 324) may be sensed through sensors 172_{1-Q}. Also, in one or more embodiments, leakage of breathable air 103 from safety system 100 (e.g., fixed piping system 104, at emergency air fill stations 120_{1-P}, isolation valves 160_{1-P}, air storage system 106 such as compressed air source 108/air storage tanks 108_{1-N}/another compressed air source 109) may also be sensed through appropriate sensors 172_{1-Q} (e.g., leakage sensor 326). In one example implementation, leakage sensor 326 may be an ultrasound sensor that senses high sound frequencies of leaks of breathable air 103. Said leaks, if not addressed appropriately, may result in catastrophic loss of breathable air 103 from safety system 100. In one or more embodiments, once sensors 172_{1-Q} detect the leakage of breathable air 103, again, bypass controller device 140 may automatically be triggered to bypass air storage system 106/compressed air source 108/another compressed air source 109, as discussed above.

Thus, in one or more embodiments, the capabilities of air quality analysis device 105 and/or remote certification laboratory 118 may be extended to accommodate detection of parameters such as pressure and leakage of breathable air 103. All reasonable variations are within the scope of the exemplary embodiments discussed herein.

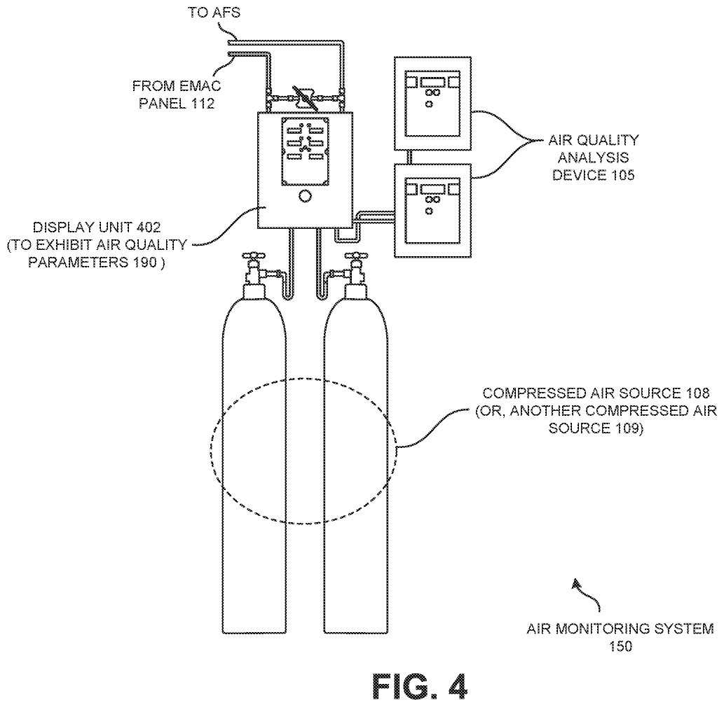

FIG. 4 shows air monitoring system 150 discussed above in an example implementation form. Here, air monitoring system 150 may be a collection of units and/or components put together to check and record quality (and/or pressure/leakage) of breathable air 103 and components thereof within safety system 100. Air quality analysis device 105 may include a display unit 402 associated therewith (e.g., part of or external to air quality analysis device 105). to exhibit air quality parameters 190 captured and/or analyzed through air quality analysis device 105. Display unit 402 may be part of an Android™-based data processing device (e.g., a tablet, a notebook) with a touchscreen for visual presentation of air quality parameters 190.

Display unit 402, as discussed herein, may be an electromechanical device installed at key locations of structure 102, and air quality analysis device 105 may be made of one or more material(s) having fire-rated capabilities. A video camera (not shown) installed on or integrated with display unit 402 may capture visual incidents at the key locations that are accessible at fire command center 115, fire control room 113 and/or data processing device 136 through cloud computing network 114. Air quality parameters 190 may be monitored in accordance with standard fire safety guidelines (e.g., NFPA guidelines, Occupational Safety and Health Administration (OSHA) and/or Compressed Gas Association (CGA) standards).

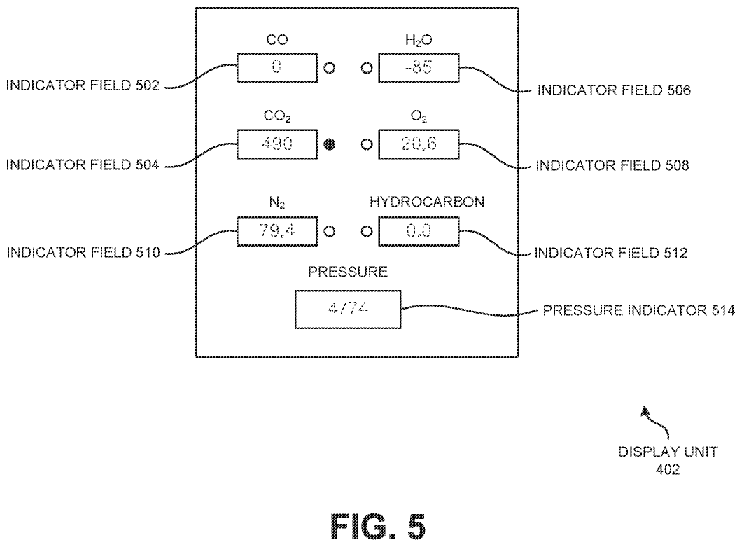

FIG. 5 shows an example display unit 402 associated with air quality analysis device 105 of FIG. 4. Display unit 402 may include various indicator fields to exhibit air quality parameters 190 captured and/or analyzed by air quality analysis device 105 in real-time. For example, indicator field 502 may be associated with carbon monoxide content in breathable air 103 (e.g., from air storage system 106/compressed air source 108), indicator field 504 may be associated with carbon dioxide content in breathable air 103, indicator field 510 may be associated with nitrogen content in breathable air 103, indicator field 506 may be associated with moisture content breathable air 103, indicator field 508 may be associated with oxygen content in breathable air 103, and indicator field 512 may be associated with hydrocarbon content in breathable air 103. In addition, display unit 402 may include a pressure indicator 514 to exhibit air pressure of breathable air 103 (e.g., air sample 178).

Further, display unit 402 may include indicator lights (not shown) to indicate changes in air quality parameters 190 through changes in colors of lights emitted therefrom. Still further, display unit 402 may include, for example, a Quick Response (QR) scanner (not shown)to enable emergency personnel 122 to scan and check statuses of air quality parameters 190.

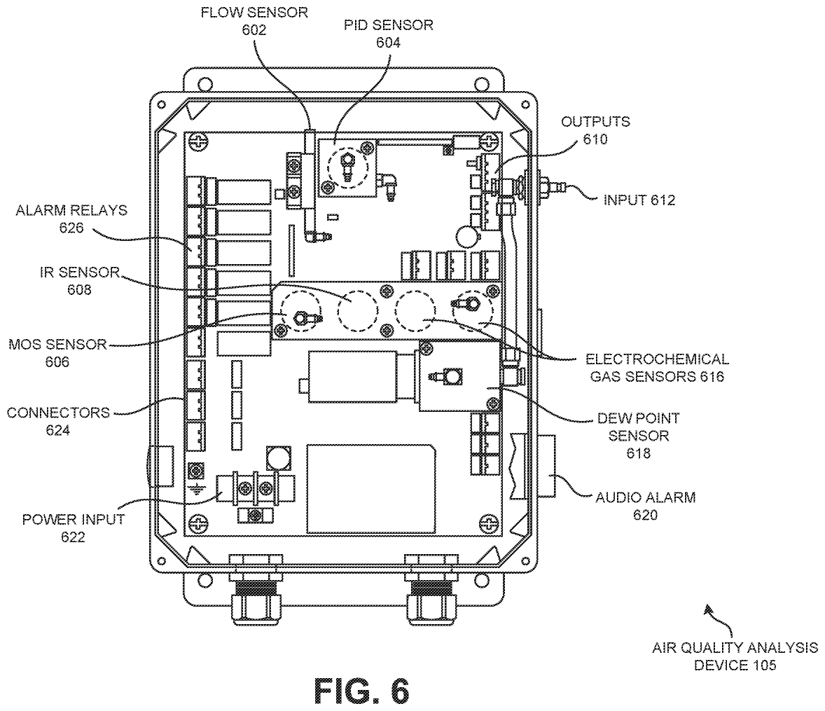

FIG. 6 shows an example air quality analysis device 105. Air quality analysis device 105 may include a flow sensor 602 (e.g., an electronic device) that measures and/or regulates a flow rate of breathable air 103 (e.g., from compressed air source 108, another compressed air source 109) within fixed piping system 104. A photoionization detector (PID) sensor 604 of air quality analysis device 105 may detect low concentrations of volatile organic compounds (VOCs)/hazardous substances in breathable air 103. In one example implementation, PID sensor 604 may utilize ultraviolet (UV) light to break down said VOCs in breathable air 103 into positive and negative ions, following which a charge of the ionized gas as a function of concentration of the VOCs in breathable air 103 is detected and/or measured.

A Metal Oxide Semiconductor (MOS) sensor 606 of air quality analysis device 105 may detect concentrations of various types of gases in breathable air 103/air sample 178 by measuring a change in resistance of a metal oxide due to adsorption of gases in breathable air 103/air sample 178. An infrared (IR) sensor 608 of air quality analysis device 105 may measure and/or detect infrared radiation in a surrounding environment of air quality analysis device 105. All sensors discussed herein may be part of sensors 172_{1-Q} discussed above.

Outputs 610 may be in the form of electrical signals used to identify air components of breathable air 103/air sample 178. The electrical signals may be generated by sensors 172_{1-Q} including the sensors discussed herein. An input 612 may be an intake of breathable air 103/air sample 178 (e.g., through a hose) from compressed air source 108/another compressed air source 109/air storage system 106.

An electromechanical gas sensor 616 of air quality analysis device 105 may be operated based on a diffusion of a gas of interest (e.g., air components of breathable air 103/air sample 178) thereinto. Said diffusion may result in generation of an electrical signal proportional to a concentration of the gas of interest. A dew point sensor 618 of air quality analysis device 105 may be used to measure and/or monitor a dew point temperature of breathable air 103/air sample 178. An audio alarm 620 may be a transducer device to emit an audible alert once an emergency state is detected by sensors 172_{1-Q}. A power input 622 may be an input corresponding to an amount of energy put into and/or consumed by air quality analysis device 105. Connectors 624 may be links between electrical components of air quality analysis device 105.

An alarm relay 626 may be an electric switch that activates bypass controller device 140 when anomalies (e.g., contamination in breathable air 103) and/or faults (e.g., fire hazards, pressure variations, deviation in predefined air/air quality parameters, etc.) are detected by sensors 172_{1-Q}, following which bypass controller device 140 may enable automatic bypassing of air storage system 106/compressed air source 108/another compressed air source 109 as discussed above. In one or more embodiments, air monitoring system 150 may be made of fire-rated material to protect safety system 100 from physical damage during hazardous situations. Further, in one or more embodiments, air monitoring system 150 may be made of weather-resistant and/or UV/solar/infrared radiation-resistant material/material(s) to prevent corrosion and/or deterioration of components thereof due to prolonged exposure to harsh environmental and/or weather conditions.

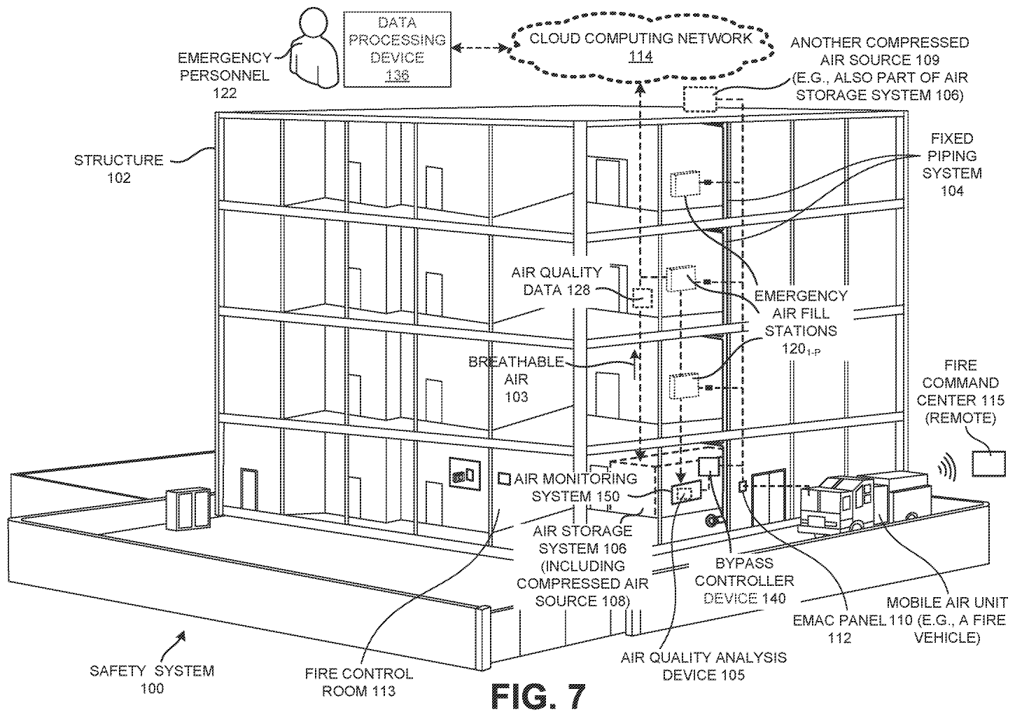

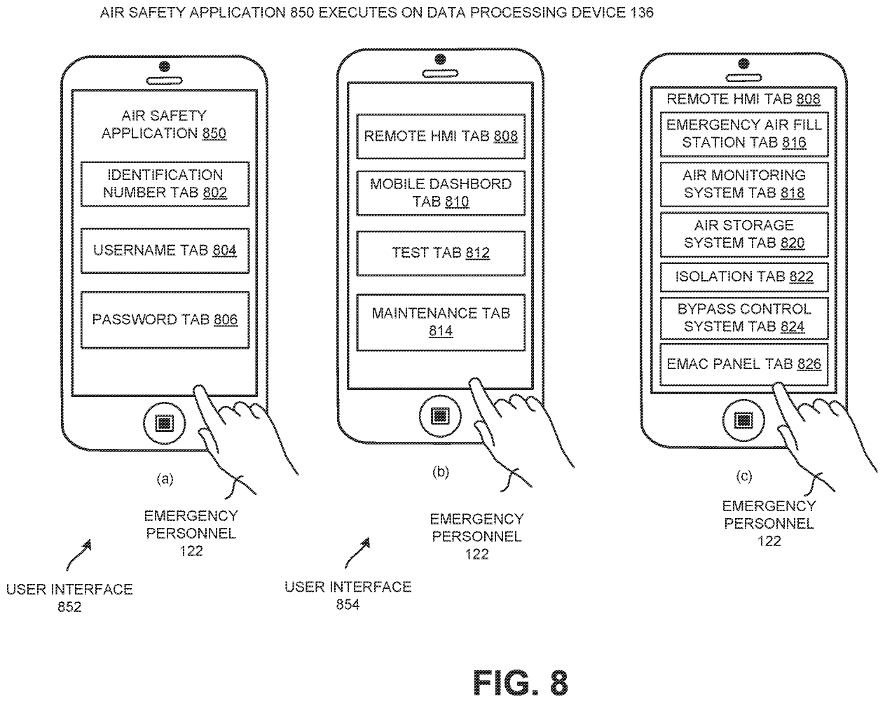

FIG. 7 shows safety system 100 implemented in a horizontal configuration of structure 102 and communication therewithin, according to one or more embodiments. All concepts discussed in this Application may also be applicable to FIG. 7. FIG. 8 shows an example user interface 852 of an air safety application 850 executing on data processing device 136 (e.g., on a processor communicatively coupled to a memory thereof). As shown in ‘(a)’, user interface 852 may display user authentication tabs of air safety application 850. Example user authentication tabs may include an identification number tab 802, a username tab 804, and a password tab 806. Emergency personnel 122 (e.g., authorized users, firefighters, emergency responses.) may need to enter a corresponding identification number, username and password to access features provided through air safety application 850.

As shown in ‘(b)’, upon authentication, example user interface 854 may display a remote Human-Machine Interface (HMI) tab 808, a mobile dashboard tab 810, a test tab 812, and a maintenance tab 814. Remote HMI tab 808 may help emergency personnel 122 to remotely control safety system 100. Mobile dashboard tab 810 may help show a real-time graphical display of an entirety of safety system 100. Test tab 812 may help emergency personnel 122 to request analysis of breathable air 103 through remote certification laboratory 118 and generate custom reports. Maintenance tab 814 may help provide a proactive dimension to view upcoming and/or current maintenance requirements of safety system 100.

As shown in ‘(c)’, remote HMI tab 808 may display an emergency air fill station tab 816, an air monitoring system tab 818, an air storage system tab 820, an isolation tab 822, a bypass control system tab 824, and an EMAC panel tab 826. Remote HMI tab 808 may enable emergency personnel 122 to control components associated with the aforementioned tabs to effect automatic bypass of air storage system 106/compressed air source 108/another compressed air source 109, as discussed above, and obtain air quality parameters 190. Based on zeroing in on specific tabs discussed herein, more detailed operations such as controlling relay devices, requesting certification through remote certification laboratory 118, purging breathable air 103 from safety system 100, isolating compressed air source 108/another compressed air source 109/air storage system 106 and so on are within the scope of the exemplary embodiments discussed herein.

In one or more embodiments, based on detection of emergency state(s) of safety system 100 and/or anomalous air quality parameters 190 through sensors 172_{1-Q} via data processing device 136, fire command center 115 and/or fire control room 113, emergency personnel 122 may be able to purge safety system 100 of contaminated/bad/anomalous breathable air 103 prior to switching from one compressed air source (e.g., compressed air source 108) to another compressed air source (e.g., another compressed air source 109). In some other embodiments, leakage (e.g., detected through leakage sensor 326) of breathable air 103 may require plugging in of leak(s) in components of safety system 100 and/or fixing said components prior to reuse of the same compressed air source (e.g., air storage system 106, compressed air source 108, another compressed air source 109). The aforementioned tasks are instantaneously notified to emergency personnel 122 in accordance with one or more implementations of safety system 100 discussed herein. All reasonable variations are within the scope of the exemplary embodiments discussed herein.

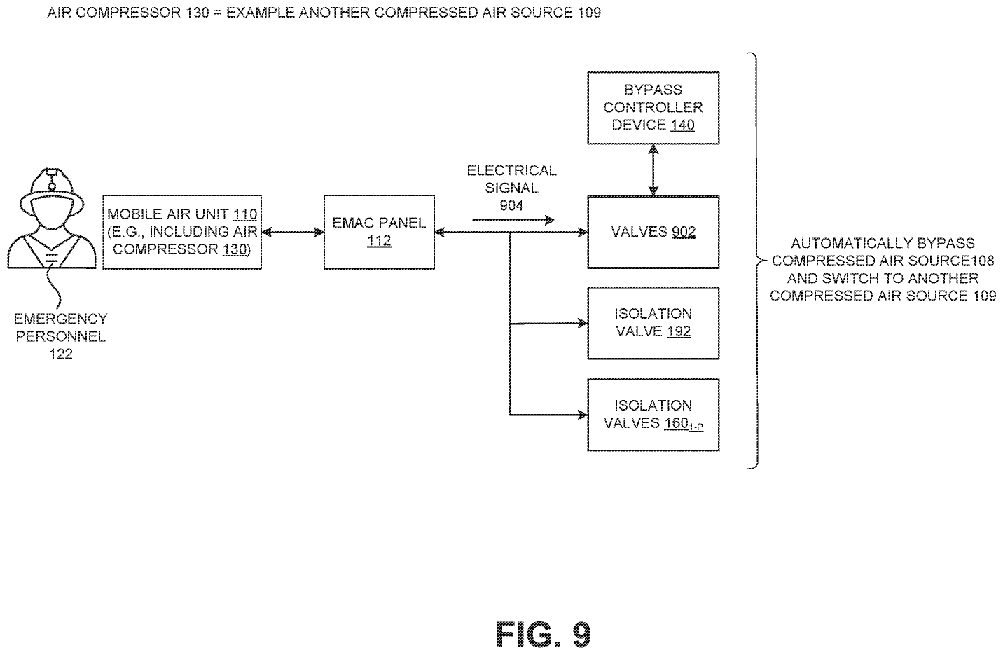

It should be noted that, in one or more embodiments, in the case of another compressed air source 109 being mobile air unit 110 with air compressor 130, bypass controller device 140 may be implemented with one or more check valves and/or one or more automatic actuator selector valves remotely operable from EMAC panel 112 readily accessible by emergency personnel 122. FIG. 9 shows control of valves 902 (e.g., check valves, automatic actuator selector valves) implemented in conjunction with bypass controller device 140/isolation valve 192/isolation valves 160_{1-P} remotely from EMAC panel 112 by emergency personnel 122, according to one or more embodiments. In one or more embodiments, in response to an electrical signal 904 from EMAC panel 112 (e.g., following detection of anomalies/faults in air quality parameters 190), valves 902/isolation valve 192/isolation valves 160_{1-P} may be controlled to enable automatic bypass/isolation of compressed air source 108 with respect to breathable air 103 within safety system 100 and automatic switching to another compressed air source 109 (e.g., air compressor 130 on mobile air unit 110) to ensure direct and continued supply of breathable air 103 from another compressed air source 109 within safety system 100. In the case of control of isolation valve 192/isolation valves 160_{1-P} through electrical signal 904, isolation valve 192 and/or isolation valves 160_{1-P} may also be implemented with check valves and/or automatic actuator selector valves. All reasonable variations are within the scope of the exemplary embodiments discussed herein.

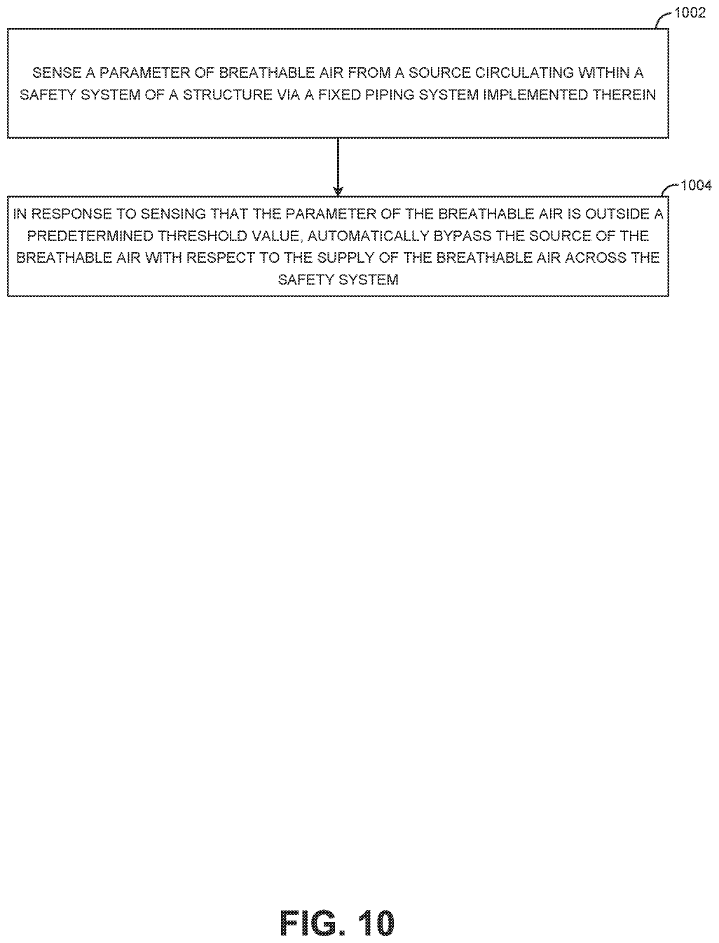

FIG. 10 shows a process flow diagram detailing the operations involved in air parameter based automatic bypassing of a source (e.g., compressed air source 108) of breathable air (e.g., breathable air 103) in a safety system (e.g., safety system 100) of a structure (e.g., structure 102) having a fixed piping system (e.g., fixed piping system 104) implemented therein to supply the breathable air across the safety system, according to one or more embodiments. In one or more embodiments, operation 1002 may involve sensing (e.g., through sensors 172_{1-Q} of with air analysis device 105) a parameter (e.g., air quality parameters 190) of the breathable air circulating within the safety system. In one or more embodiments, operation 1004 may then involve, in response to detecting that the parameter of the breathable air is outside a predetermined threshold value (e.g., part of predetermined air quality parameters/thresholds 188) based on the sensing, automatically bypassing (e.g., using a bypass controller device 140 communicatively coupled to air analysis device 105) the source of the breathable air with respect to the supply of the breathable air across the safety system.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method of a safety system of a structure having a fixed piping system installed therewithin to supply breathable air from a source across the safety system, comprising:
sensing a parameter of the breathable air circulating within the safety system; and
in response to detecting that the parameter of the breathable air is outside a predetermined threshold value based on the sensing, automatically bypassing the source of the breathable air with respect to the supply of the breathable air across the safety system.

2. The method of claim 1, further comprising:
installing an air analysis device along an air flow path of the breathable air from the source within the safety system;
sensing the parameter of the breathable air using a sensor associated with the air analysis device; and
automatically bypassing the source of the breathable air using a bypass controller device communicatively coupled to the air analysis device.

3. The method of claim 2, further comprising, in response to the detection of the parameter of the breathable air being outside the predetermined threshold value based on the sensing, through the bypass controller device, switching from the source of the breathable air to another source of the breathable air in the safety system in addition to the automatic bypassing of the source of the breathable air to ensure a continued supply of the breathable air across the safety system.

4. The method of claim 1, comprising the parameter of the breathable air comprising at least one of: an air quality parameter, an air component parameter, a pressure of the breathable air, a temperature of the breathable air, and leakage thereof.

5. The method of claim 2, further comprising remotely certifying the safety system via a data processing device communicatively coupled to the air analysis device in accordance with determining that the automatically detected parameter of the breathable air within the safety system is within the predetermined threshold value.

6. The method of claim 3, further comprising at least one of: automatically bypassing the source of the breathable air and switching to the another source of the breathable air based on controlling, through the bypass controller device, at least one valve associated with at least one component of the safety system.

7. The method of claim 2, comprising the sensor associated with the air analysis device comprising at least one of: a carbon monoxide sensor configured to sense a level of carbon monoxide in the breathable air, a carbon dioxide sensor configured to sense a level of carbon dioxide in the breathable air, an oxygen sensor configured to sense a level of oxygen in the breathable air, a nitrogen sensor configured to sense a level of nitrogen in the breathable air, a hydrocarbon sensor configured to sense a condensed hydrocarbon content in the breathable air, and a moisture sensor configured to sense a moisture concentration in the breathable air.

8. The method of claim 2, comprising the sensor comprising at least one of: a pressure sensor configured to sense a pressure of the breathable air and a leakage sensor configured to sense leakage of the breathable air in the safety system.

9. The method of claim 3, further comprising sampling the breathable air from at least one of: the source and the another source of the breathable air instantaneously through at least one of: the air analysis device and a data processing device communicatively coupled to the air analysis device through a computer network.

10. The method of claim 3, further comprising controlling at least one valve associated with at least one of: the bypass controller device, the source of the breathable air, the another source of the breathable air and an emergency air fill station of the structure through a mobile air connection panel external to the structure to enable utilization of a mobile air unit as the another source of the breathable air.

11. A method of a safety system of a structure having a fixed piping system installed therewithin to supply breathable air from a source across the safety system, comprising:
sensing a parameter of the breathable air circulating within the safety system; and
in response to detecting that the parameter of the breathable air is outside a predetermined threshold value based on the sensing:
automatically bypassing the source of the breathable air with respect to the supply of the breathable air across the safety system; and
switching from the source of the breathable air to another source of the breathable air in the safety system in addition to the automatic bypassing of the source of the breathable air to ensure a continued supply of the breathable air across the safety system.

12. The method of claim 11, further comprising:
installing an air analysis device in an air flow path of the breathable air from the source within the safety system;
sensing the parameter of the breathable air using a sensor associated with the air analysis device; and
automatically bypassing the source of the breathable air and switching to the another source of the breathable air using a bypass controller device communicatively coupled to the air analysis device.

13. The method of claim 11, comprising the parameter of the breathable air comprising at least one of: an air quality parameter, an air component parameter, a pressure of the breathable air, a temperature of the breathable air, and leakage thereof.

14. The method of claim 12, further comprising remotely certifying the safety system via a data processing device communicatively coupled to the air analysis device in accordance with determining that the automatically detected parameter of the breathable air within the safety system is within the predetermined threshold value.

15. The method of claim 12, further comprising at least one of: automatically bypassing the source of the breathable air and switching to the another source of the breathable air based on controlling, through the bypass controller device, at least one valve associated with at least one component of the safety system.

16. The method of claim 12, comprising the sensor comprising at least one of: a carbon monoxide sensor configured to sense a level of carbon monoxide in the breathable air, a carbon dioxide sensor configured to sense a level of carbon dioxide in the breathable air, an oxygen sensor configured to sense a level of oxygen in the breathable air, a nitrogen sensor configured to sense a level of nitrogen in the breathable air, a hydrocarbon sensor configured to sense a condensed hydrocarbon content in the breathable air, a moisture sensor configured to sense a moisture concentration in the breathable air, a pressure sensor configured to sense a pressure of the breathable air , and a leakage sensor configured to sense leakage of the breathable air in the safety system.

17. The method of claim 12, further comprising sampling the breathable air from at least one of:
the source and the another source of the breathable air instantaneously through at least one of:
the air analysis device and a data processing device communicatively coupled to the air analysis device through a computer network.

18. A safety system of a structure, comprising:
a source of breathable air;
a fixed piping system installed within the structure for supply of the breathable air across the safety system;
an air analysis device along an air flow path of the breathable air from the source thereof, the air analysis device comprising a sensor associated therewith to automatically detect a parameter of the breathable air circulating within the safety system; and
a bypass controller device communicatively coupled to the air analysis device to, in response to detecting that the parameter of the breathable air is outside a predetermined threshold value, automatically bypass the source of the breathable air with respect to the supply of the breathable air across the safety system.

19. The safety system of claim 18, wherein, in response to the detection of the parameter of the breathable air being outside the predetermined threshold value, the bypass controller device further switches from the source of the breathable air to another source of the breathable air in the safety system in addition to the automatic bypassing of the source of the breathable air to ensure a continued supply of the breathable air across the safety system.

20. The safety system of claim 18, wherein the parameter of the breathable air comprises at least one of: an air quality parameter, an air component parameter, a pressure of the breathable air, a temperature of the breathable air, and leakage thereof.

21. The safety system of claim 19, wherein the bypass controller device at least one of: automatically bypasses the source of the breathable air and switches to the another source of the breathable air based on controlling at least one valve associated with at least one component of the safety system.

22. The safety system of claim 18, wherein the sensor associated with the air analysis device comprises at least one of: a carbon monoxide sensor configured to sense a level of carbon monoxide in the breathable air, a carbon dioxide sensor configured to sense a level of carbon dioxide in the breathable air, an oxygen sensor configured to sense a level of oxygen in the breathable air, a nitrogen sensor configured to sense a level of nitrogen in the breathable air, a hydrocarbon sensor configured to sense a condensed hydrocarbon content in the breathable air, a moisture sensor configured to sense a moisture concentration in the breathable air, a pressure sensor configured to sense a pressure of the breathable air, and a leakage sensor configured to sense leakage of the breathable air in the safety system.
